(19) United States
(12) Patent Application Publication
(10) Pub. No.: US 2021/0356317 A1
(43) Pub. Date: Nov. 18, 2021

(54) COMPLEX AND PHASE DOMAIN VIBRATION STRENGTH ESTIMATION FOR COHERENT DISTRIBUTED ACOUSTIC SENSING

(71) Applicant: NEC Laboratories America, Inc., Princeton, NJ (US)

(72) Inventors: Ezra IP, West Windsor, NJ (US); Junqiang HU, Davis, CA (US); Yue-Kai HUANG, Princeton, NJ (US)

(73) Assignee: NEC LABORATORIES AMERICA, INC, Princeton, NJ (US)

(21) Appl. No.: 17/317,863

(22) Filed: May 11, 2021

Related U.S. Application Data
(60) Provisional application No. 63/026,367, filed on May 18, 2020.

(51) Int. Cl. G01H 9/00; G01D 5/353

(52) U.S. Cl. CPC G01H 9/004; G01D 5/35361

(57) ABSTRACT

Aspects of the present disclosure describe a coherent distributed acoustic sensing (DAS) method employing a combined complex and phase domain vibration strength estimation are employed to produce a distributed acoustic sensing output signal exhibiting mitigated Rayleigh fading effect. Operationally, a phase-domain estimator is regulated by a complex-domain estimator that provides Rayleigh fading information associated with each DAS fiber segment, which in turn is used to determine if/how a phase-domain estimator is affected by fading. In the occurrence of severe fading, the complex-domain estimator is used to produce an indication of vibration strength, wherein noise occurring in that estimator is not amplified as would be in the phase-domain estimator.

### CROSS REFERENCE

This disclosure claims the benefit of U.S. Provisional Patent Application Ser. No. 63/026,367 filed May 18, 2020 the entire contents of which is incorporated by reference as if set forth at length herein.

### TECHNICAL FIELD

This disclosure relates generally to distributed fiber optic sensing and more particularly to distributed acoustic sensing on multi-span fiber links.

### BACKGROUND

As is known, distributed fiber optic sensing (DFOS) and more particularly distributed acoustic sensing (DAS) has shown great utility when applied to any number of applications including infrastructure monitoring, oil and gas operation and earthquake detection.

Distributed acoustic sensing systems use the Rayleigh scattering effect in optical fiber to detect changes in the fiber strain. The dynamic strain signal, which is calculated from a reflected optical signal produced at fiber locations along its length, is used to detect vibration and acoustic signals along the entire length of a sensing fiber (cable) undergoing interrogation. To derive the strain signal and obtain the vibration strength, most DAS systems rely on calculating an optical signal phase change either via differential segment beating or point referencing method.

Unfortunately, the accuracy of the phase change calculation may be influenced by the Rayleigh fading effect, as Rayleigh scattering is a random effect in optical fiber. As such, there exists a possibility that at certain locations along the fiber the signal strength will fade below system noise level. When such fading occurs, errors in the calculation of the phase result. Even in a relatively quiet environment (static fading), the heavily faded locations could produce an erroneous indication of high vibration, if direct phase calculation is used to determine the vibration strength. In environments where large vibrations are common occurrences (aerial cable/fence installation), the vibration signal itself could cause the DAS signal to fade near or below the noise level, thus creating phase calculation instabilities at these time instances (dynamic fading).

### SUMMARY

The above problems are solved and an advance in the art is made according to aspects of the present disclosure directed to systems, methods, and structures for distributed acoustic sensing. In sharp contrast to the prior art, systems, methods, and structures according to aspects of the present disclosure employ a “combined complex and phase domain vibration strength estimation” wherein two methods of calculating the vibration strength are used to produce a DAS output signal exhibiting a mitigated influence from the Rayleigh fading effect.

Operationally, systems, methods, and structures according to the present disclosure use a complex-domain signal estimator to determine a signal envelope and whether a location along a length of sensing fiber in a received DAS signal is experiencing a fade. The knowledge of fading location(s) are then used determine whether a phase-domain estimator output can be used as vibration strength indication. Finally, a combined complex-domain and phase-domain vibration estimate is used to mitigate any influence of Rayleigh fading on vibration strength results.

### BRIEF DESCRIPTION OF THE DRAWING

A more complete understanding of the present disclosure may be realized by reference to the accompanying drawing in which:

FIG. 1 shows a schematic diagram of an illustrative prior art distributed fiber optic sensing system for distributed acoustic sensing (DAS) as generally known in the art;

FIG. 2 shows a flow diagram illustrating combined complex and phase domain vibration strength estimation according to aspects of the present disclosure;

FIG. 3(A) and FIG. 3(B) are plots showing: FIG. 3(A) amplitude profile of typical DAS differential beating signal; and FIG. 3(B) calculated vibration strength profile using complex domain estimator and phase domain estimator according to aspects of the present disclosure;

FIG. 4(A), FIG. 4(B) and FIG. 4(C) are plots showing calculated vibration strength using complex-domain estimator with different estimator amplitude in which: FIG. 4(A) is 1V; FIG. 4(B) is 2V; and FIG. 4(C) is 5V according to aspects of the present disclosure; and

FIG. 5(A), FIG. 5(B) and FIG. 5(C) are plots showing comparisons of vibration strength profile calculated using complex-domain estimator and combined estimator at stretcher amplitude in which: FIG. 5(A) is 1V; FIG. 5(B) is 2V; and FIG. 5(C) is 5V according to aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

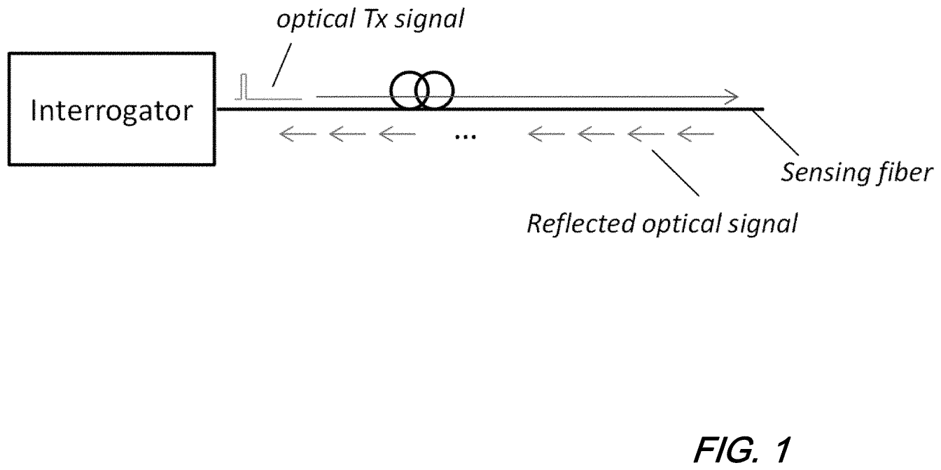

By way of some additional background—and with reference to FIG. 1 which is a schematic diagram of an illustrative distributed fiber optic sensing system for distributed acoustic sensing (DAS) generally known in the art—we begin by noting that distributed fiber optic sensing (DFOS) is an important and widely used technology to detect environmental conditions such as temperature (distributed temperature sensing—DTS), vibration (distributed vibration sensing—DVS), stretch level etc. anywhere along an optical fiber cable that in turn is connected to an interrogator. As is known, contemporary interrogators are systems that generate an input signal to the fiber and detects/analyzes the reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. It can also be a signal of forward direction that uses the speed difference of multiple modes. Without losing generality, the following description assumes reflected signal though the same approaches can be applied to forwarded signal as well.

As will be appreciated, a contemporary DFOS system includes an interrogator that periodically generates optical pulses (or any coded signal) and injects them into an optical fiber. The injected optical pulse signal is conveyed along the optical fiber.

At locations along the length of the fiber, a small portion of signal is reflected and conveyed back to the interrogator. The reflected signal carries information the interrogator uses to detect, such as a power level change that indicates—for example—a mechanical vibration.

The reflected signal is converted to electrical domain and processed inside the interrogator. Based on the pulse injection time and the time signal is detected, the interrogator determines at which location along the fiber the signal is coming from, thus able to sense the activity of each location along the fiber.

Those skilled in the art will understand and appreciate further that Distributed Acoustic Sensing (DAS) using coherent optical time-domain reflectometry (OTDR) based on Rayleigh backscatter is a well-known technique for detecting acoustic vibrations.

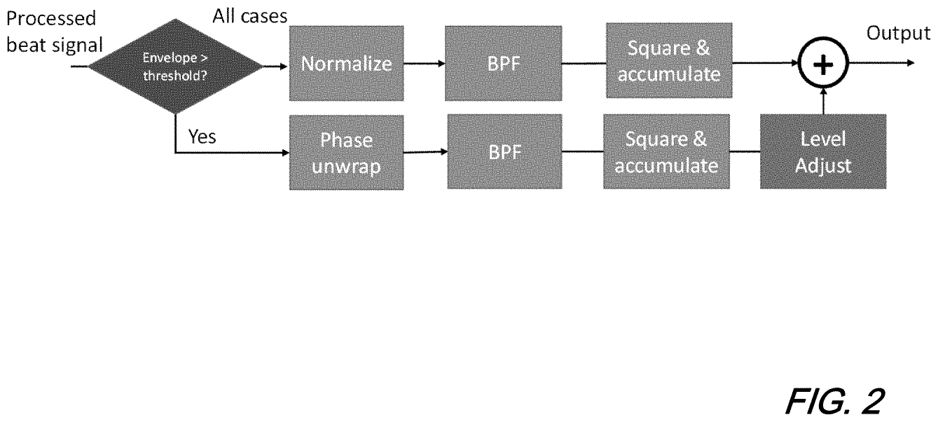

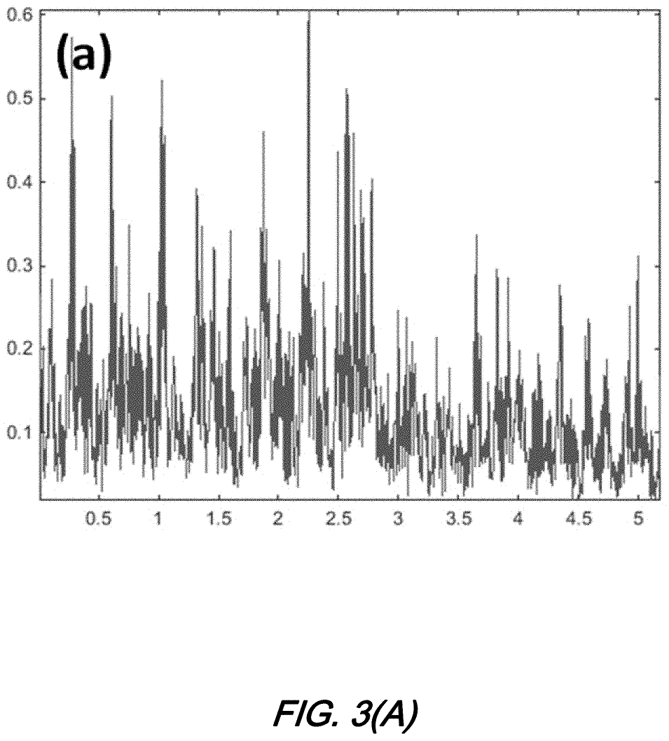

FIG. 2 shows a flow diagram illustrating combined complex and phase domain vibration strength estimation according to aspects of the present disclosure. In the flow chart shown in the figure, we illustratively show how two different vibration strength determination methods can be combined.

With reference to that figure, we assume that pre-processing of a DAS system will produce a beating signal (beat signal) in complex form (real and imaginary values) for each monitored sensing location along a length of sensing fiber, and a combined vibration strength estimator will use the beat signal as input for vibration strength determination. The upper (top) path in the flow diagram uses the signal strength directly in the complex domain to estimate the vibration strength, while the lower (bottom) path in the flow diagram first determines a phase trajectory of the signal before estimation of the vibration strength.

Note that to estimate the vibration strength using a complex signal, a signal normalization step is required because each sensing fiber location will receive a different DC beating bias due to a random Rayleigh scattering effect. Once the DC bias is normalized across different sensing fiber locations, a band pass filter is applied to a complex signal at each sensing fiber location to set the frequency region of interest for the monitored vibration. The filtered signal is then squared and accumulated over multiple samples to estimate the vibration strength at the rate to match the output refresh rate.

In estimating the vibration strength using phase signal, an additional step is taken to calculate the unwrapped phase value. The normalization step is skipped because DC bias will be removed after phase calculation. The same band pass filter can be applied to the phase signal associated with each location to set the frequency region of interest for the monitored vibration. Finally, the filtered signal is squared and accumulated over multiple samples to estimate the vibration strength at the rate to match the output refresh rate.

We note that using an unwrapped phase signal for vibration strength estimation has both advantages and disadvantages. Due to phase unwrapping, the calculation/determination can trace the underlying signal trajectory beyond a dynamic range of (−π, π) imposed in the complex domain. However, since DAS beating results can frequently experience Rayleigh fading, the phase calculation can introduce a significant amount of noise in a Rayleigh faded location.

A method according to aspects of the present disclosure advantageously cures this infirmity by first calculating the DC bias envelope of each location to determine the fading probability before calculating the phase signal. If the DC bias envelope is above a predetermined threshold (low fading probability), the unwrapped phase signal is computed, and vibration strength is estimated using both methods combined. If the DC bias envelope is below the predetermined threshold, only a complex signal-based estimation result will be used. Note that the estimated strength from the phase signal will also undergo an additional a nonlinear level adjustment step to suppress lower strength results, as the estimator typically has higher noise than the complex signal-based method.

DSP preprocessing is first used to obtain the distributed differential beating signal in a coherent DAS system. The beat signal is computed by using the beat products between complex-valued Rayleigh reflected signals at two separate locations. In a coherent DAS platform, four beating products ζₓₓ, ζ_{yy}, ζ_{xy}, ζ_{yx} are computed in parallel at each different location, and the beat-product vectors are combined into one signal stream using a multi-polarization-state (MPSC) combining process by proper weighting and vector rotation techniques. The obtained distributed beat signal for each fiber location can then be used to calculate the dynamic fiber strain, and vibration strength at each location can also be estimated.

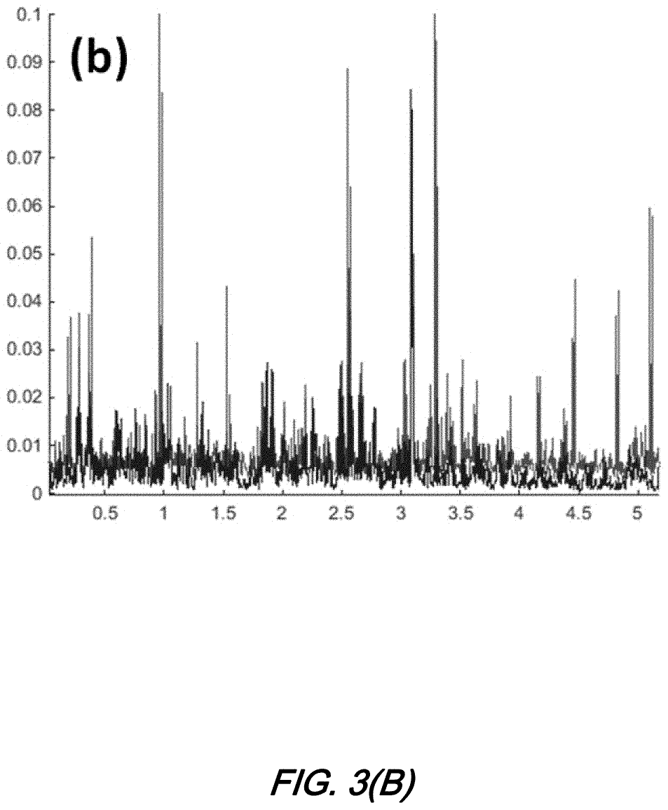

FIG. 3(A) and FIG. 3(B) are plots showing: FIG. 3(A) amplitude profile of typical DAS differential beating signal; and FIG. 3(B) calculated vibration strength profile using complex domain estimator and phase domain estimator according to aspects of the present disclosure.

In FIG. 3(A), a plot of amplitude profile of one pre-processed beat signal in a coded DAS system in distributed fashion is shown. The total length of a monitored sensing fiber section is 5 km (after initial 50 km fiber spool between monitored section and the coded DAS interrogator) with a spatial resolution of −5 meter per point. As can be clearly observed, the amplitude of the beat signal exhibits very high fluctuations due—in part—to random Rayleigh back scattering.

Note that with respect to most sensing fiber locations, the beat signal exhibits enough power above the noise level, but at several instances it drops below the system noise level due to Rayleigh fading.

The vibration is simulated using a fiber stretcher placed at a ˜3.1-km location. When calculating the vibration strength, we can perform the calculation in the complex-domain, as shown in FIG. 3(B), as well as in the phase-domain after phase unwrapping. In the region where the beat signal is heavily faded, the signal is inundated by noise and the phase unwrapping calculation will influenced by noise, which creates the large spikes making it difficult to find the actual vibration location.

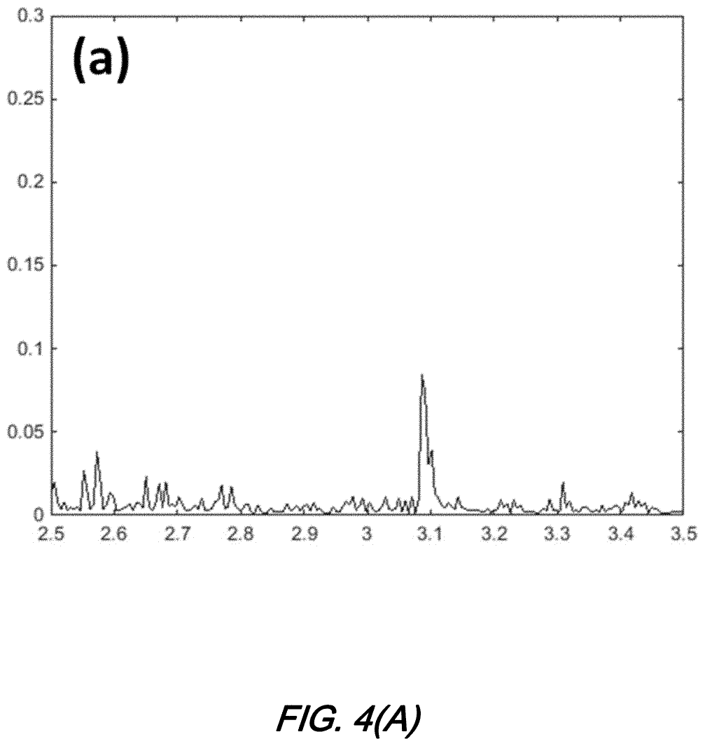

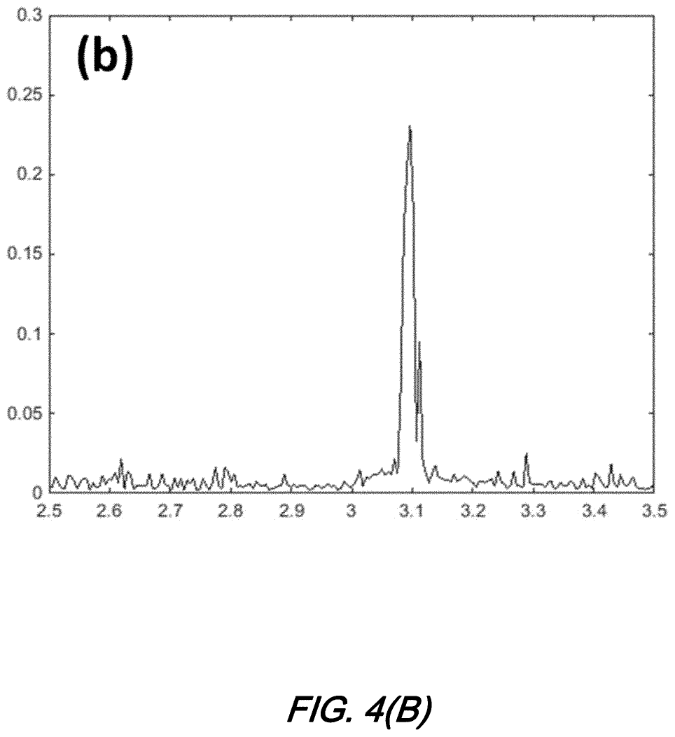

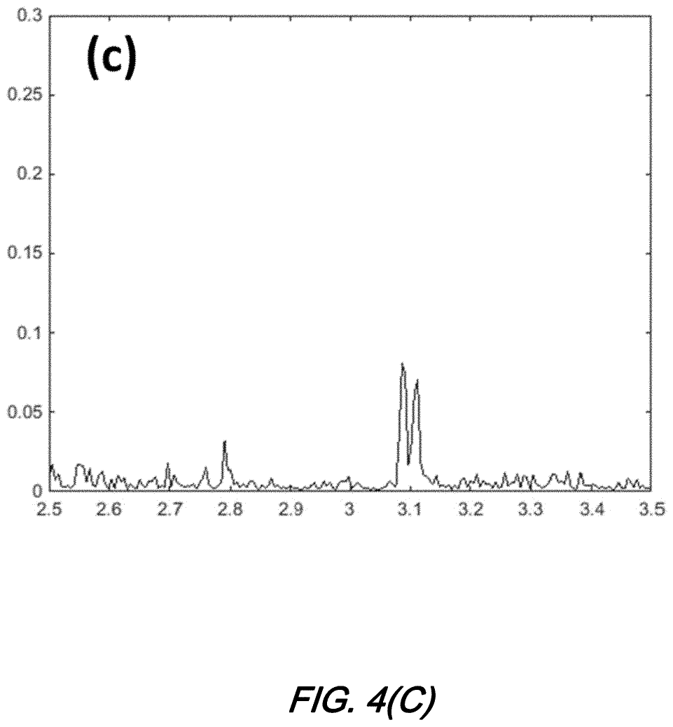

FIG. 4(A), FIG. 4(B) and FIG. 4(C) are plots showing calculated vibration strength using complex-domain estimator with different estimator amplitude in which: FIG. 4(A) is 1V; FIG. 4(B) is 2V; and FIG. 4(C) is 5V according to aspects of the present disclosure.

We note that using a complex-domain estimator is not without problems either. Even though it is more immune to Rayleigh fading induced noise spikes, it nevertheless has difficulty estimating large vibration strength(s) due—in part—to limited dynamic range.

In the plots, we plot the vibration strength profile of the same section of the monitored fiber with different stretcher input, changing from 1V, to 2V, to 5V. The stretching amplitude corresponds to a round-trip phase amplitude of 1.6 rad, 3.2 rad, and 6.4 rad. As may be observed, the calculated vibration strength peak actually drops as stretching amplitude is varied from 2V to 5V. This is due to the stretching amplitude approaching the 2 π dynamic range of the complex-domain estimator, and extra signal energy has transferred to higher order harmonics and is not included in the strength estimation.

As illustratively shown in FIG. 2, our inventive method solves the shortcomings of both approaches by applying a conditional block before the calculation of the unwrapped phase signal, as shown in that FIG. 2. If the location has a low signal envelope (estimate using low-pass filtering or averaging) and has high likelihood of Rayleigh fading, only the complex-domain estimator on the upper (top) path of the flow chart will be used for vibration strength. If the signal envelope has power above the threshold set in the condition, then unwrapped phase calculation can be used estimate the vibration strength and combine with the complex-domain estimator.

Note that the same BPF and accumulation settings are be applied to the upper (top) path and the lower (bottom) path of the flow chart to maintain the observed signal band accumulation time the same. Before combination, a level adjustor is applied to the path of unwrapped phase estimator so that the values between the two paths can be compared at the same level. The level adjustor can also exhibit a nonlinear transfer function, so that any final results will be dominated more by the phase-unwrapped estimator in large vibration locations.

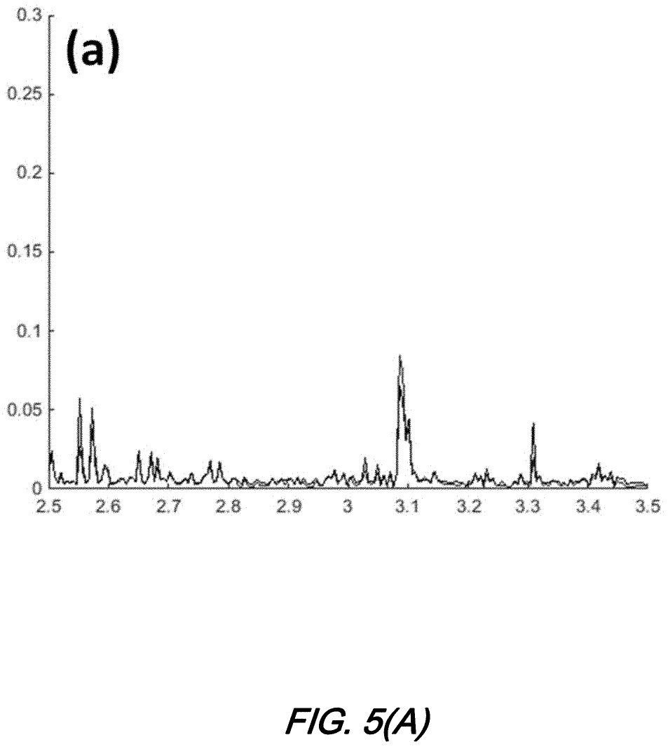

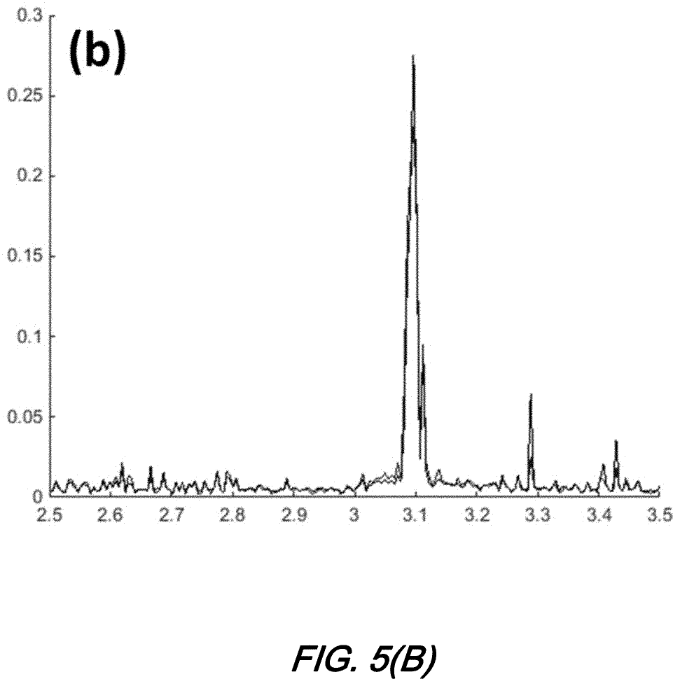

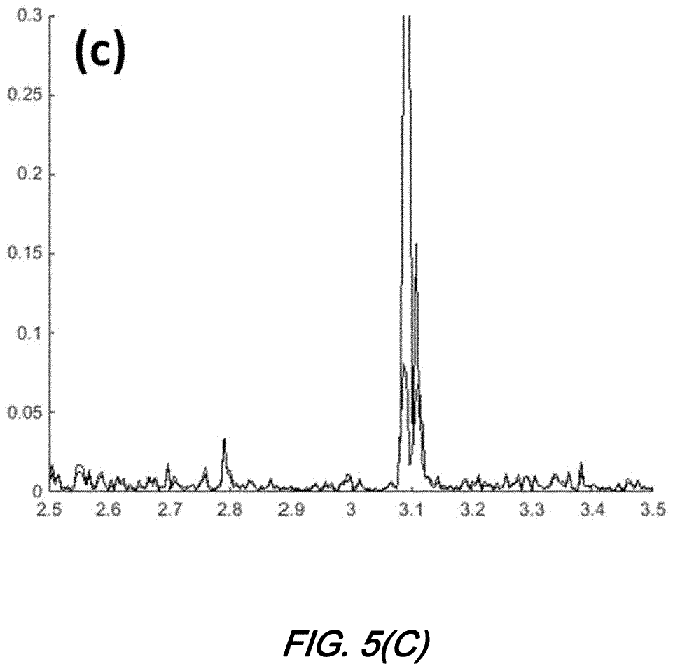

FIG. 5(A), FIG. 5(B) and FIG. 5(C) are plots showing comparisons of vibration strength profile calculated using complex-domain estimator and combined estimator at stretcher amplitude in which: FIG. 5(A) is 1V; FIG. 5(B) is 2V; and FIG. 5(C) is 5V according to aspects of the present disclosure.

With reference to these figures, we compare the calculated vibration strength results from the combined estimator to the one that uses complex-domain calculation only. At the fiber regions outside the stretcher location, the combined estimator now has similar profile as the complex-domain estimator, free of the Rayleigh fading induced noise spikes as shown in FIG. 3(B). At the stretcher location—because the combined estimator can also take the unwrapped phase calculation into account—it can measure above the dynamic range limit set in the complex domain estimator. We observed that the combined results do indeed increase in vibration strength as the stretcher amplitude get turned up from 1V to 5V. In this example, an error function was used as the nonlinear function to adjust the level of the phase estimator for combination. Other nonlinear function can also be used for the purpose of letting the phase result dominate in large vibration while suppressing the noise in low vibration regions.

While we have presented this disclosure using some specific examples, those skilled in the art will recognize that our teachings are not so limited. Accordingly, this disclosure should be only limited by the scope of the claims attached hereto.

1. A method of operating a distributed fiber optic sensing (DFOS)/distributed acoustic sensing (DAS) system, said system comprising:
a length of optical fiber; and
a DFOS/DAS sensing interrogator including coherent detector and analyzer in optical communication with the length of optical fiber;
said method comprising:
operating the DFOS/DAS sensing interrogator to determine vibration sources occurring at one or more points along the length of the optical fiber;
THE METHOD CHARACTERIZED BY:
combined complex and phase domain vibration strength estimation.

2. The method of claim 1 FURTHER CHARACTERIZED BY:
determining, by a complex-domain estimator, signal envelope and DAS signal fading locations at points along the length of the optical fiber.

3. The method of claim 2 FURTHER CHARACTERIZED BY:
determining fading location(s) along the length of the optical fiber and determining the phase domain vibration strength estimation using the determined fading location(s).

4. The method of claim 3 FURTHER CHARACTERIZED BY:
applying a user-defined threshold based on an average background complex signal power to determine the fading location(s).

5. The method of claim 1 FURTHER CHARACTERIZED BY:
applying complex domain vibration strength estimation only in Rayleigh faded regions along the length of the optical fiber.

6. The method of claim 5 FURTHER CHARACTERIZED BY:
applying a non-liner level adjustment to the phase domain estimate such that noise occurring in low vibration regions of the optical fiber is suppressed.
